(19) United States
(12) Patent Application Publication
(10) Pub. No.: US 2025/0353944 A1
(43) Pub. Date: Nov. 20, 2025

(54) POLYETHYLENE COMPOSITIONS AND RELATED BICOMPONENT FIBERS, NONWOVEN FABRICS, AND METHODS

(71) Applicant: EXXONMOBIL CHEMICAL PATENTS INC., Spring, TX (US)

(72) Inventors: Zeng Zeng YAO, Shanghai (CN); Yan SHEN, Shanghai (CN); Haiqing PENG, Sugar Land, TX (US); Trudy L. IACCINO, Seabrook, TX (US); Richard E. PEQUENO, Baytown, TX (US)

(21) Appl. No.: 18/870,997

(22) PCT Filed: May 24, 2023
(86) PCT No.: PCT/US2023/067405

§ 371 Date: Dec. 2, 2024

Related U.S. Application Data
(60) Provisional application No. 63/366,315, filed on Jun. 13, 2022.

(51) Int. Cl. C08F 210/16; C08F 2/01; C08F 4/64; D01D 5/08; D01D 5/12; D01F 8/10; D01F 8/14; D01G 1/04; D04H 1/541

(52) U.S. Cl. CPC C08F 210/16; C08F 2/01; C08F 4/64003; D01D 5/08; D01D 5/12; D01F 8/10; D01F 8/14; D01G 1/04; D04H 1/5412; C08F 2400/02; D10B 2321/021; D10B 2331/04

(57) ABSTRACT

A polyethylene copolymer may comprise about 90 wt % to about 99.99 wt % ethylene and about 0.01 wt % to about 10 wt % an alpha-olefin that is not ethylene, wherein the polyethylene has: a density of about 0.930 g/cm³ to about 0.955 g/cm³, a melt flow index (2.16 kg at 190°° C.) of about 10 g/10 min to about 50 g/10 min, a melt flow index ratio (MIR) of about 15 to about 25, a weight average molecular weight to number average molecular weight ratio (Mw/Mn) of about 2 to about 4, a wt % of TREF elution at 90° C. and less of about 10 wt % to about 80 wt %, and a wt % of TREF elution at 95° C. and greater of about 3 wt % or more. Said polyethylene may be especially well-suited for making bicomponent fibers, which may be useful producing in nonwoven fabrics.

### CROSS-REFERENCE TO RELATED APPLICATION

This application claims the benefit of U.S. Provisional Application No. 63/366,315, filed Jun. 13, 2022, entitled “POLYETHYLENE COMPOSITIONS AND RELATED BICOMPONENT FIBERS, NONWOVEN FABRICS, AND METHODS”, the entirety of which is incorporated by reference herein.

### FIELD OF INVENTION

The present disclosure relates to polyethylene, bicomponent fibers comprising the polyethylene, nonwoven fabrics comprising the bicomponent fibers, and methods relating to any of the foregoing.

### BACKGROUND

Air-through bonded nonwovens are fabrics that are bonded through heat, typically hot air, using processes that are also referred to as air-through bonding. Air-through bonded nonwovens, which may also be referred to as air-through nonwovens, offer several advantages including bulkiness, softness, and good hand feel. These nonwoven fabrics are also advantageous because of the lack chemical bonding agents. As a result, air-through nonwovens are useful in the manufacture of a wide range of articles, especially disposable hygiene goods such as diapers, sanitary napkins, training pants, and adult incontinence products.

Air-through nonwovens are conventionally produced from multilayered fibers. Generally speaking, these multilayered fibers include a core of a relatively high melt polymer encased within sheath comprising a polymer having a lower melt temperature. Hot air is applied to at least partially melt the sheath and thereby bond or heat set the fibers to each other. The nonwoven fabric to which the air-through bonding is applied can be formed by a variety of technologies including carding, spunbonding, airlaying, thermal bonding, wetlaying, and spunlacing, and the like. Conventionally, many air-through bonded nonwoven fabrics are prepared from carded multilayer staple fiber webs or spunmelt nonwoven webs of multilayered fibers.

Multilayered fibers, which are also referred to as multicomponent fibers, are often prepared by using a spinning process in which separate polymer streams are fed to a single die or spinneret in order to form fibers having two (or more) polymer phases. While many structural variations of multicomponent fibers exist, sheath-core (or core-sheath) multicomponent fibers are often used in the manufacture of air-through nonwoven fabrics, especially those used in the manufacture of disposable hygiene products.

Polyethylene is a polymer that may be used in any portion of a multicomponent fiber. For example, in core-sheath bicomponent fibers, polyethylene may be used in the sheath and contribute structurally to the bonding and physically to the hand feel of a resultant nonwoven fabric.

For example, U.S. Pat. No. 7,300,988 discusses how to increase catalyst productivity from 1000 grams of polymer per gram of the catalyst (g/g) to about 5000 g/g by increasing reactor pressure from about 300 psi to about 350 psi when using bis(n-propylcyclopentadienyl) hafnium dichloride and difluoride as the catalysts. However, the molecular architectures such as molecular distribution and short chain branching distribution are not discussed, and moreover, achieving this productivity required a low density polyethylene with substantial comonomer loading (0.918 g/cm³ density), and furthermore resulted in very low melt index (MI) polyethylene (e.g., 0.69 g/10 min), with a rather high melt index ratio (MIR, ratio of high-load melt index to melt index) of 31. The reference provides no direction or suggestion on achieving similarly high catalyst productivity for higher melt index, higher-density polymers, as would be needed for fiber applications.

In another example, U.S. Pat. No. 9,181,362 also discloses polyethylenes produced by using a silica-supported bis (n-propyl cyclopentadienyl) hafnium dichloride catalyst. By using reactor temperature greater than 85° C. and operating pressure from about 300 psi to about 375 psi, the inventive polyethylenes have Mw/Mn greater than 3 and monomodal short chain branching distribution according to the temperature rising elution fraction (TREF) curves.

### SUMMARY OF INVENTION

The present disclosure relates to polyethylene, bicomponent fibers comprising the polyethylene, nonwoven fabrics comprising the bicomponent fibers, and methods relating to any of the foregoing.

A nonlimiting example composition of the present disclosure comprises: polyethylene comprising about 90 wt % to about 99.99 wt % ethylene and about 0.01 wt % to about 10 wt % an alpha-olefin that is not ethylene, wherein the polyethylene has: a density of about 0.930 g/cm³ to about 0.955 g/cm³, a melt flow index (2.16 kg at 190° C.) of about 10 g/10 min to about 50 g/10 min, a melt flow index ratio (MIR) of about 15 to about 30, a weight average molecular weight to number average molecular weight ratio (Mw/Mn) of about 2 to about 4, a wt % of TREF elution at 90° C. and less of about 10 wt % to about 80 wt %, and a wt % of TREF elution at 95° C. and greater of about 3 wt % or more.

A nonlimiting example method of the present disclosure comprises: polymerizing ethylene and an alpha-olefin that is not ethylene in a fluidized bed gas reactor in the presence of a hafnocene catalyst to produce a polyethylene, wherein a reactor pressure is less than 300 psig, wherein polyethylene comprises 90 wt % to 99.99 wt % of the ethylene and 0.01 wt % to about 10 wt % of the alpha-olefin, and wherein the polyethylene has: a density of about 0.930 g/cm³ to about 0.955 g/cm³, a melt index (2.16 kg at 190° C.) of about 10 g/10 min to about 50 g/10 min, a melt index ratio (MIR) of about 15 to about 30, a weight average molecular weight to number average molecular weight ratio (Mw/Mn) of about 2 to about 4, a TREF elution at 90° C. and less of about wt % to about 80 wt %, and a TREF elution at 95° C. and greater of about 3 wt % or more.

A nonlimiting example bicomponent fiber of the present disclosure comprises: a first polymeric component comprising one or more of: a polypropylene, a polyethylene terephthalate, a polyamide, a poly (oxyethylene glycol) polymer, a polyoxymethylene, or a polyether ether ketone; and a second polymeric component comprising: polyethylene comprising about 90 wt % to about 99.99 wt % ethylene and about 0.01 wt % to about 10 wt % an alpha-olefin that is not ethylene, wherein the polyethylene has: a density of about 0.930 g/cm³ to about 0.955 g/cm³, a melt flow index (2.16 kg at 190° C.) of about 10 g/10 min to about 50 g/10 min, a melt index ratio (MIR) of about 15 to about 30, a weight average molecular weight to number average molecular weight ratio (Mw/Mn) of about 2 to about 4, a wt % of TREF elution at 90° C. and less of about 10 wt % to about 80 wt %, and a wt % of TREF elution at 95° C. and greater of about 3 wt % or more.

A nonlimiting example method of the present disclosure comprises: melt spinning a bicomponent fiber, wherein the bicomponent fiber comprises: a first polymeric component comprising one or more of: a polypropylene, a polyethylene terephthalate, a polyamide, a poly(oxyethylene glycol) polymer, a polyoxymethylene, or a polyether ether ketone; and a second polymeric component comprising: polyethylene comprising about 90 wt % to about 99.99 wt % ethylene and about 0.01 wt % to about 10 wt % an alpha-olefin that is not ethylene, wherein the polyethylene has: a density of about 0.930 g/cm³ to about 0.955 g/cm³, a melt flow index (2.16 kg at 190° C.) of about 10 g/10 min to about 50 g/10 min, a melt index ratio (MIR) of about 15 to about 30, a weight average molecular weight to number average molecular weight ratio (Mw/Mn) of about 2 to about 4, a wt % of TREF elution at 90° C. and less of about 10 wt % to about 80 wt %, and a wt % of TREF elution at 95° C. and greater of about 3 wt % or more; cutting the bicomponent fiber into bicomponent staple fiber; producing a nonwoven fabric with the bicomponent staple fiber with an air-through bonding temperature of about 180° C. or less.

These and other features and attributes of the disclosed methods and compositions of the present disclosure and their advantageous applications and/or uses will be apparent from the detailed description which follows.

### BRIEF DESCRIPTION OF THE DRAWINGS

To assist those of ordinary skill in the relevant art in making and using the subject matter hereof, reference is made to the appended drawings. The following figures are included to illustrate certain aspects of the disclosure, and should not be viewed as exclusive configurations. The subject matter disclosed is capable of considerable modifications, alterations, combinations, and equivalents in form and function, as will occur to those skilled in the art and having the benefit of this disclosure.

FIG. 1 is a TREF comparison for some of the polyethylenes.

FIG. 2 is a graph of wt % of polymer eluted below 90° C. in a TREF experiment, vs. density of the polymer, for various polyethylene polymers in connection with the Examples.

### DETAILED DESCRIPTION

The present disclosure relates to polyethylene, bicomponent fibers comprising the polyethylene, products comprising the bicomponent fibers, and methods relating to any of the foregoing. More specifically, the present disclosure includes compositions and methods of producing a polyethylene with properties that, when used to produce a bicomponent fiber and then a nonwoven fabric, translate to a softer, more fluffy feel nonwoven material. Further, the polyethylene described herein may have a broad temperature window for bonding that extends into lower temperatures that, when bonded, maintains the fiber-to-fiber bond strength and, consequently, maintains the nonwoven fabric mechanical properties. The broad temperature window for bonding and possibility of lower temperatures advantageously improves manufacturing flexibility and may lower power consumption used in heating air for bonding.

### Definitions and Test Methods

Unless otherwise indicated, room temperature is 25° C.

An “olefin,” alternatively referred to as “alkene,” is a linear, branched, or cyclic compound of carbon and hydrogen having at least one double bond.

A “polymer” has two or more of the same or different mer units. A “homopolymer” is a polymer having mer units that are the same. The term “polymer” as used herein includes, but is not limited to, homopolymers, copolymers, terpolymers, etc. The term “polymer” as used herein also includes impact, block, graft, random, and alternating copolymers. The term “polymer” shall further include all possible geometrical configurations unless otherwise specifically stated. Such configurations may include isotactic, syndiotactic, and random symmetries.

As used herein, unless specified otherwise, the term “copolymer(s)” refers to polymers formed by the polymerization of at least two different monomers (i.e., mer units). For example, the term “copolymer” includes the copolymerization reaction product of propylene and an alpha-olefin, such as ethylene, 1-hexene. A “terpolymer” is a polymer having three mer units that are different from each other. Thus, the term “copolymer” is also inclusive terpolymers and tetrapolymers, such as, for example, the copolymerization product of a mixture of ethylene, propylene, 1-hexene, and 1-octene.

“Different” as used to refer to monomer mer units indicates that the mer units differ from each other by at least one atom or are different isomerically. An “ethylene polymer” or “ethylene copolymer” is a polymer or copolymer comprising at least 50 mole % ethylene derived units, a “propylene polymer” or “propylene copolymer” is a polymer or copolymer comprising at least 50 mole % propylene derived units, and so on. For purposes of this invention, a polyethylene is an ethylene polymer.

As used herein, when a polymer is referred to as “comprising, consisting of, or consisting essentially of” a monomer, the monomer is present in the polymer in the polymerized/derivative form of the monomer. For example, when a copolymer is said to have an “ethylene” content of 35 wt % to 55 wt %, it is understood that the mer unit in the copolymer is derived from ethylene in the polymerization reaction and said derived units are present at 35 wt % to 55 wt %, based upon the weight of the copolymer. Thus, a polymer or copolymer said to have 90 wt % “ethylene” content is equivalent to a polymer or copolymer said to have 90 wt % “ethylene-derived” content, or 90 wt % “units derived from ethylene”, or the like.

The distribution and the moments of molecular weight (Mw, Mn, Mz, Mw/Mn, Mz/Mn, etc.) and the monomer/comonomer content (C2, C4, C6 and/or C8, and/or others, etc.), as well as g′(vis), are determined by using a high temperature Gel Permeation Chromatography (Polymer Char GPC-IR) equipped with a multiple-channel band-filter based Infrared detector IR5, an 18-angle light scattering detector and a viscometer. Three Agilent PLgel 10 μm Mixed-B LS columns are used to provide polymer separation. Detailed analytical principles and methods for molecular weight determinations and g′(vis) are described in paragraphs [0044]-[0051] of PCT Publication WO2019/246069A1, which are incorporated herein by reference (noting that the equation c=///referenced in Paragraph [0044] therein for concentration (c) at each point in the chromatogram, is c=βI, where β is mass constant and I is the baseline-subtracted IR5 broadband signal intensity (I)). Unless specifically mentioned, all the molecular weight moments used or mentioned in the present disclosure are determined according to the absolute determination methods (e.g., as referenced in Paragraphs [0044]-[0051] of the just-noted publication), noting that for the equation in such Paragraph [0044], a=0.695 and K=0.000579(1−0.75 Wt) are used, where Wt is the weight fraction for comonomer, and further noting that comonomer composition is determined by the ratio of the IR5 detector intensity corresponding to CH₂ and CH₃ channel calibrated with a series of PE and PP homo/copolymer standards whose nominal values are predetermined by NMR or FTIR (providing methyls per 1000 total carbons (CH3/1000 TC)) as noted in Paragraph [0045] of the just-noted PCT publication). Other parameters needed can be found in the referenced passage in the WO2019/246069A1 publication, but some are included here for convenience: n=1.500 for TCB at 145° C.; I=665nm; dn/dc=0.1048 mL/mg.

Density values for polymers were measured by displacement method according to ASTM D1505-10.

Melt flow index or melt index (MI) and high load melt index (HLMI) are each measured according to ASTM D1238-13 on a Goettfert MI-4 Melt Indexer, with MI (sometimes referred to as I₂) measured at 190° C., 2.16 kg load; and HLMI (sometimes referred to as I₂₁) measured at 190° C., 21.6 kg load. An amount of 5 g to 6 g of sample was loaded into the barrel of the instrument at 190° C. and manually compressed. Afterwards, the material was automatically compacted into the barrel by lowering all available weights onto the piston to remove all air bubbles. Data acquisition was started after a 6 min pre-melting time.

Melt flow index ratio or melt index ratio (MFR or MIR, equivalently) is the ratio HLMI/MI (or I₂₁/I₂).

Broad orthogonal composition distribution (BOCD) index relates to the short chain branching and was calculated according to PCT/US2021/072552, Paragraph 0052, referred to therein as “Mn−Mz Comonomer Slope Index,” which uses log MW=log Mn as the low point and log MW=log Mz as the high point for slope determination. The Mn and Mz used in determining the BOCD index was based on absolute GPC values.

The short chain branching per 1000 total carbon (SCB/1000C) along the molecular weight is determined according to Paragraph 0048 of PCT/US2021/072552 where SCB/1000 C=(comonomer wt %)*140/(comonomer molecular weight). So, for a 1-hexene comonomer, SCB/1000C=(comonomer wt %)*140/84, and for 1-octene, is SCB/1000 C=(comonomer wt %)*140/112.

Temperature rising elution fraction (TREF) is described in Monrabal, B. & del Hierro, P., Characterization of polypropylene-polyethylene blends by temperature rising elution and crystallization analysis fractionation, ANALYTICAL & BIOANALYTICAL CHEM. 399, 1557-1561 (Springer 2011), which is fully incorporated herein by reference. TREF analysis herein was performed on the CRYSTAF-TREF 200+ instrument from Polymer Char, S. A., Valencia, Spain. Briefly, about 10 mg to 25 mg of sample was dissolved in 25 mL of orthodichlorobenzene (ODCB) stirring at 150° C. A small volume (about 0.5 mL) of the solution was introduced into a column packed with an inert support of stainless steel balls at 150° C., and the column temperature was stabilized at 140° C. for about 45 min. The sample volume was then allowed to crystallize in the column by reducing the temperature to 0° C. at a cooling rate of 1° C./min. The column was kept at the lower temperature before injecting the ODCB flow (1 mL/min) into the column for 10 min to elute and measure the polymer that did not crystallize (soluble fraction). The infrared detector used (Polymer Char IR4) generates an absorbance signal that is proportional to the concentration of polymer in the eluting flow. A complete TREF curve was then generated by increasing the temperature of the column from the lower temperature to 140° C. at a rate of 2° C./min while maintaining the ODCB flow at 1 mL/min to elute and measure the dissolving polymer. TREF peak elution temperature is defined as the temperature at the maximum dW/dT ([wt %]/° C.). TREF 50 wt % elution temperature is defined as the temperature when accumulated 50 weight % of composition is eluted.

### Polyethylene and Polyethylene Synthesis

The present disclosure includes methods of producing a polyethylene that may include polymerizing ethylene and an alpha-olefin that is not ethylene in the presence of a hafnocene catalyst. During polymerization, an activator and/or hydrogen may also be present.

The hafnocene catalyst is a hafnium transition metal metallocene-type catalyst system as described in U.S. Pat. Nos. 6,242,545 and/or 6,248,845, hereby incorporated by reference. Non-limiting examples of hafnocene catalysts include, but are not limited to, bis(n-propyl cyclopentadienyl) hafnium dichloride; bis(n-propyl cyclopentadienyl) hafnium dimethyl; bis(n-propyl cyclopentadienyl) hafnium dihydride; bis(n-butyl cyclopentadienyl) hafnium dichloride; bis(n-butyl cyclopentadienyl) hafnium dimethyl; bis(n-pentyl cyclopentadienyl) hafnium dichloride; bis(n-pentyl cyclopentadienyl) hafnium dimethyl; (n-propyl cyclopentadienyl)(n-butyl cyclopentadienyl) hafnium dichloride; (n-propyl cyclopentadienyl)(n-butyl cyclopentadienyl) hafnium dimethyl; bis[(2-trimethylsilyl-ethyl) cyclopentadienyl] hafnium dichloride; bis[(2-trimethylsilyl-ethyl) cyclopentadienyl] hafnium dimethyl; bis(trimethylsilyl cyclopentadienyl) hafnium dichloride; bis(trimethylsilyl cyclopentadienyl) hafnium dimethyl; bis(trimethylsilyl cyclopentadienyl) hafnium dihydride; bis (2-n-propyl indenyl) hafnium dichloride; bis(2-n-propyl indenyl) hafnium dimethyl; bis(2-n-butyl indenyl) hafnium dichloride; bis(2-n-butyl indenyl) hafnium dimethyl, dimethylsilyl bis(n-propyl cyclopentadienyl) hafnium dichloride; dimethylsilyl bis(n-propyl cyclopentadienyl) hafnium dimethyl; dimethylsilyl bis(n-butyl cyclopentadienyl) hafnium dichloride; dimethylsilyl bis(n-butyl cyclopentadienyl) hafnium dimethyl; bis(9-n-propyl fluorenyl) hafnium dichloride; bis(9-n-propyl fluorenyl) hafnium dimethyl; bis(9-n-butyl fluorenyl) hafnium dichloride; bis(9-n-butyl fluorenyl) hafnium dimethyl; (9-n propyl fluorenyl)(2-n-propyl indenyl) hafnium dichloride; (9-n propyl fluorenyl)(2-n-propyl indenyl) hafnium dimethyl; bis(1,2-n-propyl, methyl cyclopentadienyl) hafnium dichloride; bis(1,2-n-propyl, methyl cyclopentadienyl) hafnium dimethyl; (n-propyl cyclopentadienyl) (1,3-n-propyl, n-butyl cyclopentadienyl) hafnium dichloride; (n-propyl cyclopentadienyl) (1,3-n-propyl, n-butyl cyclopentadienyl) hafnium dimethyl; the like; and any combination thereof.

Activators that may be used in conjunction with the hafnocene catalyst may include a Lewis acid or a non-coordinating ionic activator or ionizing activator or any other compound that can convert a neutral metallocene catalyst component to a metallocene cation. Examples of activators that may be used in conjunction with the hafnocene catalyst may include, but are not limited to, alumoxane, modified alumoxane, tri (n-butyl) ammonium tetrakis(pentafluorophenyl) boron metalloid precursor, a trisperfluorophenyl boron metalloid precursor, the like, and any combination thereof. Additional disclosure regarding the activators may be found in U.S. Pat. Nos. 6,242,545 and/or 6,248,845, hereby incorporated by reference.

The hafnocene catalyst and/or the activator may be supported on a supporting material like porous support materials (e.g., talc, inorganic oxides, inorganic chlorides, and/or magnesium chloride), resinous support materials (e.g., polystyrene or polystyrene divinyl benzene polyolefins or polymeric compounds), or any other organic or inorganic support material, and any combination thereof. Additional disclosure regarding the supporting materials may be found in U.S. Pat. Nos. 6,242,545 and/or 6,248,845, hereby incorporated by reference.

The mole ratio of the metal of the activator component to the transition metal of the metallocene component is in the range of ratios between 0.3:1 to 1000:1, preferably 20:1 to 800:1, and most preferably 50:1 to 500:1. Where the activator is an aluminum-free ionizing activator such as those based on the anion tetrakis(pentafluorophenyl)boron, the mole ratio of the metal of the activator component to the transition metal component is preferably in the range of ratios between 0.3:1 to 3:1.

The hafnocene catalyst may have a catalyst productivity of about 7,000 grams of polymer per gram of the hafnocene catalyst (g/g) or greater (or about 7,000 g/g to about 12,000 g/g, or about 7,000 g/g to about 10,000 g/g, or about 7,000 g/g to about 9,000 g/g).

The hafnocene catalyst may be used for polymerizing ethylene and an alpha-olefin that is not ethylene. Such alpha-olefins may be olefins having 3 to 30 carbon atoms (or 3 to 12 carbon atoms, or 3 to 8 carbon atoms). Examples of such alpha-olefins may include, but are not limited to, propylene, 1-butene, 1-pentene, 4-methyl-1-pentene, 1-hexene, 1-octene, 1-decene, the like, and any combination thereof. Preferred alpha-olefins include 1-butene, 4-methyl-1-pentene, 1-hexene, and 1-octene.

The polymerization process of the present disclosure is preferably a fluidized bed gas process. Generally, a monomer stream is passed to a polymerization section. As an illustration of the polymerization section, there can be included a fluidized bed gas-phase reactor (also referred to herein as “reactor”) in fluid communication with one or more discharge tanks, surge tanks, purge tanks, and recycle compressors. The reactor may include a reaction zone in fluid communication with a velocity reduction zone. The reaction zone includes a bed of growing polymer particles, formed polymer particles, and catalyst composition particles fluidized by the continuous flow of polymerizable and modifying gaseous components in the form of make-up feed and recycle fluid through the reaction zone. Preferably, the make-up feed includes polymerizable monomer, most preferably ethylene and at least one other alpha-olefin, and may also include “condensing agents” as is known in the art and disclosed in, for example, U.S. Pat. Nos. 4,543,399, 5,405,922, and 5,462,999.

The fluidized bed has the general appearance of a dense mass of individually moving particles, preferably polyethylene particles, as created by the percolation of gas through the bed. The pressure drop through the bed is equal to or slightly greater than the weight of the bed divided by the cross-sectional area. It is thus dependent on the geometry of the reactor. To maintain a viable fluidized bed in the reaction zone, the superficial gas velocity through the bed must exceed the minimum flow required for fluidization. Preferably, the superficial gas velocity is at least two times the minimum flow velocity. Ordinarily, the superficial gas velocity does not exceed 1.5 m/sec and usually no more than 0.76 ft/sec is sufficient.

The monomers (e.g., the ethylene and the alpha-olefin) may be introduced into the polymerization zone in various ways including direct injection through a nozzle into the bed or cycle gas line. The monomers can also be sprayed onto the top of the bed through a nozzle positioned above the bed, which may aid in eliminating some carryover of fines by the cycle gas stream.

A reactor temperature (also referred to as bed temperature) of the fluidized bed process described herein may be from about 70° C. to about 110° C. (or about 70° C. to about 80° C., or about 70° C. to about 85° C., or about 75° C. to about 90° C., or about 80° C. to about 100° C.).

A reactor pressure of the fluidized bed process described herein may be about 300 psig or less (or about 100 psig to about 300 psig, or about 100 psi to about 290 psi, or about 100 psi to about 275 psi, or about 100 psig to about 200 psig, or about 200 psig to about 300 psig).

The alpha-olefin should be present at a level that will achieve the desired weight percent incorporation of the alpha-olefin into the finished polyethylene.

Hydrogen gas may also be added to the polymerization reactor(s) to control the final properties (e.g., melt flow index, melt flow ratio, bulk density, and the like) of the polyethylene composition. By way of nonlimiting example, the ratio of hydrogen to total ethylene monomer (ppm H₂:mol % C₂) in the circulating gas stream may be in a range of from 0 to about 60:1 (or about 0.10:1 (0.10) to about 50:1 (50), or about 0.12 to about 40, or about 0.15 to about 35)

The polyethylene of the present disclosure may comprise about 90 wt % to about 99.99 wt % (or about 90 wt % to about 95 wt %, or about 95 wt % to about 99.99 wt %, or about 93 wt % to about 98 wt %, or about 97 wt % to about 99 wt %, or about 99 wt % to about 99.99 wt %) of the ethylene and about 0.01 wt % to about 10 wt % (or about 5 wt % to about 10 wt %, or about 0.01 wt % to about 5 wt %, or about 2 wt % to about 7 wt %, or about 1 wt % to about 3 wt %, about 0.01 wt % to about 1 wt %) of the alpha-olefin that is not ethylene.

The polyethylene of the present disclosure may have a density of about 0.930 or 0.931 g/cm³ to about 0.950, 0.953, or 0.955 g/cm³ (or about 0.930 g/cm³ to about 0.950 g/cm³, or about 0.930 g/cm³ to about 0.945 g/cm³, or about 0.930 g/cm³ to about 0.940 g/cm³).

The polyethylene of the present disclosure may have a melt flow index (measured at 190° C. and 2.16 kg load) of about 10 g/10 min to about 50 g/10 min (or about 10 g/10 min to about 40 g/10 min, or about 10 g/10 min to about 30 g/10 min, or about 10 g/10 min to about 25 g/10 min).

The polyethylene of the present disclosure may have a melt flow index ratio (MIR) of about 12, 13, 14, or 15 to about 20, 22, 25, 27, or 30 (with ranges from any foregoing low end to any foregoing high end contemplated, such as 15 to 25, or 15 to 20, or 15 to 30).

The polyethylene of the present disclosure may have a weight average molecular weight to number average molecular weight ratio (Mw/Mn) of about 2 to about 4 (or about 2 to about 3, or about 2.0 to about 2.9, or about 2 to about 3.5, or about 2.5 to about 3.5).

The polyethylene of the present disclosure may have a g′(vis) of about 0.95 or greater (or about 0.95 to about 1.0).

The polyethylene of the present disclosure may have a wt % of TREF elution at 90° C. and less of about 10 wt % to about 80 wt % (or about 10 wt % to about 30 wt %, or about 25 wt % to about 50 wt %, or about 30 wt % to about 60 wt %, or about 50 wt % to about 80 wt %), with ranges from any foregoing low end to any foregoing high end (e.g., 25 to 60 wt %) also contemplated herein.

The polyethylene of the present disclosure may have a wt % of TREF elution at 95° C. and greater of about 3 wt % or more (or about 5 wt % or more, or about 3 wt % to about 85 wt %, or about 5 wt % to about 85 wt %, or about 3 wt % to about 35 wt %, or about 5 wt % to about 25 wt %, or about 10, 15, or 20 wt % to about 50, 55, 60, 70, 80, or 85 wt %), with ranges from any foregoing low end to any foregoing high end (e.g., 5 to 35 wt % or 5 to 60 wt %) also contemplated herein.

Generally, lower density fractions of the polyethylene have higher comonomer content and elute via TREF at lower temperatures while higher density fractions of the polyethylene have a lower comonomer content and elute via TREF at higher temperatures. Without being limited by theory, it is believed that lower density fractions broaden the bonding temperature window while higher density fractions improve bonding strength. Advantageously, the polyethylenes of the present disclosure may have both a low density fraction (e.g., illustrated by having a wt % of TREF elution at 90° C. and less of about 10 wt % to about 80 wt %) and a high density fraction a (e.g., illustrated by having wt % of TREF elution at 95° C. and greater of about 3 wt % or more).

The polyethylene of the present disclosure may have a TREF peak elution temperature that is greater than a TREF 50wt % elution temperature.

The polyethylene of the present disclosure may in various embodiments have a BOCD index (or Mn−Mz Comonomer Slope Index) of greater than about 2, 3, or 4 (or about 2 to about 7, or about 2 to about 5, or about 3 to about 5). In some embodiments, BOCD index greater than 2, 3, or 4 (i.e., a higher BOCD index) may be associated with lower-density varieties of the polyethylene (e.g., those having density 0.945 g/cm³ or less, such as 0.940 g/cm³ or less), while for higher density (e.g., greater than 0.945 g/cm³, such as 0.950 g/cm³ or more), BOCD index may be less than 2, such as less than 1.

As is discussed in more detail in connection with the EXAMPLES below, the polyethylene of the present disclosure exhibits a unique feature of tunability of its low vs. high-density fractions as a function of density (comonomer incorporation). In particular, the inventive polyethylenes (having density 0.930 to 0.955 g/cm³, or within other narrower ranges as discussed above) may follow the relationship Y>−3000X+2865, where Y is the wt % of TREF elution at 90° C. and lower; and X is the density (g/cm³) of the polyethylene. This quantifies the phenomenon allowing tunability of the polyethylenes—whereby increasing comonomer incorporation (lower density) is carried out selectively in the lower—density fraction of the polyethylene, rather than equally throughout both the lower- and higher-density fractions, such that the comonomer is incorporated with substantial preference into the low-density fraction as density decreases (comonomer incorporation increases). Importantly, the polyethylenes according to such embodiments still possess an adequate high-density fraction, illustrated through their having wt % of TREF elution at 95° C. and above of at least 3 wt %, preferably at least 5 wt % (or any other range of wt % of TREF elution at 95° C. described herein).

### Bicomponent Fibers

Bicomponent fibers of the present disclosure may comprise a first polymeric component and a second polymeric component where one of the polymeric components comprises a polyethylene of the present disclosure. Examples of polymers that may be employed in or as the other polymeric component may include, but are not limited to, propylene-based polymers (e.g., homopolymers, impact copolymers, copolymers), ethylene-based polymers (e.g., LDPE, LLDPE, HDPE (copolymers and block copolymers)), functionalized polyolefins (e.g., EXXELOR™, maleic anhydride functionalized elastomeric ethylene copolymers), plastomers (e.g., ethylene-α-olefin copolymers), polyurethane, polyesters such as polyethylene terephthalate, polylactic acid, polyvinyl chloride, polytetrafluoroethylene, styrenic block copolymers, ethylene vinyl acetate copolymers, polyamide, polycarbonate, cellulosics (e.g., RAYON™, LYOCELL™, TENCIL™), an elastomer, poly(acetylene), poly(thiophene), poly aniline), poly(fluorene), poly(pyrrole), poly(3-alkylhiophene), poly(phenylene sulphide), polynaphthalenes, poly(phenylene vinylene), poly(vinylidene fluoride), poly(oxyethylene glycol) polymers (POP), polyoxymethylene (POM), a polyether ether ketone (PEEK), and blends of any two or more of these materials. Useful polymers also include plastomers (e.g., ethylene-α-olefin copolymers and block copolymers), polyurethane, polyesters such as polyethylene terephthalate (PET), polylactic acid, polyvinyl chloride, polytetrafluoroethylene, styrenic block copolymers, ethylene vinyl acetate copolymers, polyamide, polycarbonate, cellulosics (e.g., RAYON™, LYOCELL™, TENCIL™), an elastomer, poly(acetylene), poly(thiophene), poly(aniline), poly(fluorene), poly(pyrrole), poly(3-alkylhiophene), poly(phenylene sulphide), polynaphthalenes, poly(phenylene vinylene), poly(vinylidene fluoride), the like, and blends of any two or more of these polymers. Preferred polymers include, but are not limited to, a polypropylene, a polyethylene terephthalate, a polyamide, a poly(oxyethylene glycol) polymer, a polyoxymethylene, a polyether ether ketone the like, and any blend thereof.

One or more additives may be incorporated into the first polymeric component and/or the second polymeric component. Examples of additives may include, but are not limited to, stabilizers, antioxidants, fillers, colorants, nucleating agents, dispersing agents, mold release agents, slip agents, fire retardants, plasticizers, pigments, vulcanizing or curative agents, vulcanizing or curative accelerators, cure retarders, processing aids, tackifying resins, the like, and any combination thereof. Other additives may include fillers and/or reinforcing materials, such as carbon black, clay, talc, calcium carbonate, mica, silica, silicate, the like, and any combination thereof.

The antioxidants may be primary and secondary antioxidants. Examples of antioxidants may include, but are not limited to, hindered phenols, hindered amines, phosphates, the like, and any combination thereof.

Bicomponent fibers of the present disclosure may be prepared in a melt-spun process (also known as melt spinning), which is a process that extrudes polymeric melts or solutions through spinnerets to form filaments (also known as monofilaments).

The bicomponent fibers may have a side-by-side configuration or a core-sheath configuration. In core-sheath configuration, the polyethylene of the present disclosure may be in either the core or the sheath. Preferably, the polyethylene of the present disclosure is in the sheath of a core-sheath bicomponent fiber configuration.

In one or more embodiments, the sheath-core fibers of the present invention are prepared by a melt-spun process where two polymer liquids are separately supplied to spinneret orifices and then extruded to form the sheath-core structure. In the case of concentric monofilaments, the orifice supplying the core polymer is in the center of the spinning orifice outlet and flow conditions of core polymer fluid are strictly controlled to maintain the concentricity of both components when spinning. Eccentric fiber production can include eccentric positioning of the inner polymer channel and controlling of the supply rates of the two component polymers. Alternatively, a varying element can be introduced near the supply of the sheath component melt. Alternatively, a stream of single component can be merged with a concentric sheath-core component just before emerging from the orifice. Or, spun concentric fiber can be deformed by passing over a hot edge.

The bicomponent fibers may optionally be stretched (e.g., using high speed air and/or rollers) to reduce the diameter of the bicomponent fibers.

The bicomponent fibers may optionally be treated with a hydrophobic agent or a hydrophilic agent to coat at least a portion of a surface of said bicomponent fibers. Application of said agents may be via spraying or other suitable techniques.

The bicomponent fibers described herein may have a diameter of about 1 micrometer to about 15 micrometers (or about 1 micrometer to about 10 micrometers, or about 2 micrometers to about 7 micrometers).

The bicomponent fibers may have an elongation at break of about 50% or greater (or about 50% to about 90%, or about 55% to about 75%, or about 60% to about 80%).

The bicomponent fibers may have a force at break of about 2 cN/dtex to about 4 cN/dtex (or about 2 cN/dtex to about 3 cN/dtex).

The bicomponent fibers may be formed directly into a nonwoven fabric of bicomponent fibers described herein via spunbond techniques. Alternatively, the bicomponent fibers may be cut into staple fibers and formed into nonwoven fabrics of bicomponent fibers described herein via air-through techniques.

In melt-spun techniques, nonwoven fabrics may be produced by spunbond techniques. Spunbonded fibers are generally produced, for example, by the extrusion of molten polymer (e.g., using the melt-spun conditions described above) from either a large spinneret having several thousand holes or with banks of smaller spinnerets, for example, containing as few as 40 holes. After exiting the spinneret, the molten fibers are quenched by a cross-flow air quench system, then pulled away from the spinneret and attenuated (drawn) by high speed air. Filaments formed in this manner are collected on a screen (“wire”) or porous forming belt to form the web. The web is then passed through compression rolls and then between heated calender rolls where the raised lands on one roll bond the web at points covering 10% to 40% of its area to form a nonwoven fabric.

In air-through techniques, the bicomponent fibers may be processed to produce staple fibers. Said processing steps may include (a) crimping and cutting the bicomponent fibers into bicomponent staple fibers or (b) cutting the bicomponent fibers into bicomponent staple fibers. Bicomponent staple fibers may have a length of about 10 mm to about 100 mm (or about 20 mm to about 80 mm, or about 30 mm to about 60 mm).

A nonwoven fabric of bicomponent staple fibers described herein may be formed by placing the bicomponent staple fibers on a forming bet, bulking the bicomponent staple fibers to form a web, and then subjecting the web to an air-through bonding process to thereby thermally bond or set the fibers in a nonwoven fabric.

The air-through bonding techniques may use air having a temperature of about 180° C. or less (or about 150° C. to about 180° C., or about 155° C. to about 175° C., or about 150° C. to about 170° C., or about 155° C. to about 160° C.).

The nonwoven fabrics prepared using the bicomponent fibers described herein (e.g., prepared via melt-spun techniques or air-through techniques) may be characterized by basis weight, which can be measured according to WSP (Worldwide Strategic Partners) 130.1 (05). The nonwoven fabrics may have a basis weight of about 120 g/m³ or less (or about 5 g/m³ to about 120 g/m³, or about 5 g/m³ to about 50 g/m³, or about 25 g/m³ to about 100 g/m³, or about 80 g/m³ to about 120 g/m³).

The nonwoven fabrics prepared using the bicomponent staple fibers described herein may be characterized by gauge (or weight per square meter). The nonwoven fabrics may have a gauge of about 50 g/m² or less (or about 5 g/m² to about 50 g/m², or about 5 g/m² to about 25 g/m², or about 10 g/m² to about 30 g/m², or about 25 g/m² to about 50 g/m²).

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the incarnations of the present inventions. At the very least, and not as an attempt to limit the application of the doctrine of equivalents to the scope of the claim, each numerical parameter should at least be construed in light of the number of reported significant digits and by applying ordinary rounding techniques.

One or more illustrative incarnations incorporating one or more invention elements are presented herein. Not all features of a physical implementation are described or shown in this application for the sake of clarity. It is understood that in the development of a physical embodiment incorporating one or more elements of the present invention, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

While compositions and methods are described herein in terms of “comprising” various components or steps, the compositions and methods can also “consist essentially of” or “consist of” the various components and steps. Consist essentially of, in the context of compositions, allows for 25 ppm or less (each) of impurities.

### Additional Embodiments

Embodiment 1. A composition comprising: polyethylene comprising about 90 wt % to about 99.99 wt % ethylene and about 0.01 wt % to about 10 wt % an alpha-olefin that is not ethylene, wherein the polyethylene has: a density of about 0.930 g/cm³ to about 0.955 g/cm³, a melt flow index (2.16 kg at 190° C.) of about 10 g/10 min to about 50 g/10 min, a melt flow index ratio (MIR) of 15 to 25, a weight average molecular weight to number average molecular weight ratio (Mw/Mn) of about 2 to about 4, a wt % of TREF elution at 90° C. and less of about 10 wt % to about 80 wt %, and a wt % of TREF elution at 95° C. and greater of about 3 wt % or more.
Embodiment 2. The composition of Embodiment 1, wherein one or both is true of the polyethylene: (a) a TREF peak elution temperature is greater than a TREF 50wt % elution temperature; and/or (b) the polyethylene follows the comonomer incorporation relationship Y>−3000X+2865, where Y is the wt % of TREF elution at 90° C. or less of the polyethylene, and X is the density (g/cm³) of the polyethylene. Preferably, the polyethylene has both characteristics (a) and (b).
Embodiment 3. The composition of any of Embodiments 1-2, wherein the Mw/Mn is about 2 to about 3.
Embodiment 4. The composition of any of Embodiments 1-3, wherein the density is about 0.930 g/cm³ to about 0.945 g/cm³.
Embodiment 5. The composition of any of Embodiments 1-4, wherein the polyethylene has a broad orthogonal composition distribution (BOCD) index of greater than about 2.
Embodiment 6. The composition of any of Embodiments 1-5, wherein the alpha-olefin is 1-hexene.
Embodiment 7. A method comprising: polymerizing ethylene and an alpha-olefin that is not ethylene in a fluidized bed gas reactor in the presence of a hafnocene catalyst to produce a polyethylene, wherein a reactor pressure is less than 300 psig, wherein polyethylene comprises 90 wt % to 99.99 wt % of the ethylene and 0.01 wt % to about 10 wt % of the alpha-olefin, and wherein the polyethylene has: a density of about 0.930 g/cm³ to about 0.955 g/cm³, a melt index (2.16 kg at 190° C.) of about 10 g/10 min to about 50 g/10 min, a melt index ratio (2.16 kg at 190° C. to 21.6 kg at 190° C.) of about 15 to about 30, a weight average molecular weight to number average molecular weight ratio (Mw/Mn) of about 2 to about 4, a TREF elution at 90° C. and less of about 10 wt % to about 80 wt %, and a TREF elution at 95° C. and greater of about 3 wt % or more.
Embodiment 8. The method of Embodiment 7, wherein the alpha-olefin is 1-hexene.
Embodiment 9. The method of any of Embodiments 7-8, wherein a reactor bed temperature is about 70° C. to about 80° C.
Embodiment 10. The method of any of Embodiments 7-9, wherein a catalyst productivity is about 7000 g/g or greater.
Embodiment 11. The method of any of Embodiments 7-10, wherein one or both is true: (a) a TREF peak elution temperature of the polyethylene is greater than a TREF 50wt % elution temperature of the polyethylene; and/or (b) the polyethylene follows the comonomer incorporation relationship Y>−3000X+2865, where Y is the wt % of TREF elution at 90° C. or less of the polyethylene, and X is the density (g/cm³) of the polyethylene. Preferably, the polyethylene has both characteristics (a) and (b).
Embodiment 12. The method of any of Embodiments 7-11, wherein the Mw/Mn is about 2 to about 3.
Embodiment 13. The method of any of Embodiments 7-12, wherein the density is about 0.930 g/cm³ to about 0.945 g/cm³.
Embodiment 14. The method of any of Embodiments 7-13, wherein the polyethylene has a broad orthogonal composition distribution (BOCD) index of greater than about 2.
Embodiment 15. A bicomponent fiber comprising: a first polymeric component comprising one or more of: a polypropylene, a polyethylene terephthalate, a polyamide, a poly (oxyethylene glycol) polymer, a polyoxymethylene, or a polyether ether ketone; and a second polymeric component comprising: the polyethylene any of Embodiments 1-6.
Embodiment 16. The bicomponent fiber of Embodiment 15, wherein the bicomponent fiber has the core-sheath configuration with the second polymeric component as the sheath.
Embodiment 17. The bicomponent fiber of any of Embodiments 15-16, the bicomponent fiber are a bicomponent staple fiber.
Embodiment 18. A method comprising: melt spinning the bicomponent fiber of any of Embodiments 15-16; cutting the bicomponent fiber into bicomponent staple fiber; producing a nonwoven fabric with the bicomponent staple fiber with an air-through bonding temperature of about 180° C. or less.
Embodiment 19. The method of Embodiment 18, wherein the air-through bonding temperature of about 150° C. to about 165° C.
Embodiment 20. The method of any of Embodiments 18-19 further comprising: stretching the bicomponent fiber before the cutting of the bicomponent fiber.

To facilitate a better understanding of the embodiments of the present invention, the following examples of preferred or representative embodiments are given. In no way should the following examples be read to limit, or to define, the scope of the invention.

### EXAMPLES

Polyethylene compositions were produced using an XCAT™ VP-100 Metallocene Catalyst contacted with MAO (methyl alumoxane) and supported on silica, available from Univation Tehcnologies. In a fluidized bed reactor, ethylene and 1-hexene were polymerized in the presence of the catalyst and hydrogen according to the conditions in Table 1 to produce polyethylenes according to Table 2. Table 2 also includes comparative polyethylene compositions (CE) used in comparative bicomponent fibers described below.

TABLE 1

| | Inventive | |
|---|---|---|
| | Example 1 | |
| | (IE1) | IE2 |
| Bed Temperature (° C.) | 80 | 80 |
| Reactor Pressure (psig) | 289.9 | 290.0 |
| Ethylene Concentration (mol %) | 65.73 | 65.72 |
| Ethylene Partial Pressure (psi) | 200.2 | 200.2 |
| H₂/C₂ = Gas Ratio (ppm/mol %) | 7.62 | 6.55 |
| C₆/C₂ = Gas Ratio (mol/mol) | 0.0087 | 0.0029 |
| iC₅ Composition (mol %) | 4.96 | 5.01 |
| Calculated Production Rate (lb/hr) | 167.9 | 165.9 |
| Residence Time (measured basis) (hr) | 3.8 | 4.0 |
| Catalyst Productivity (meas. Basis) (g/g) | 8920 | 9057 |

TABLE 2

| PE Sample | IE1 | IE2 |
|---|---|---|
| Density (g/cm³) | 0.939 | 0.952 |
| Melt Flow Index (190° C. with 2.16 | 19 | 23 |
| kg load) (g/10 min) | | |
| Melt Flow Index (190° C. with 21.6 | 370 | 399 |
| kg load) (g/10 min) | | |
| Melt Index Ratio | 19 | 17 |
| Mn(abs) (g/mol) | 18,083 | 17,266 |
| Mw(abs) (g/mol) | 52,873 | 49,656 |
| Mz(abs) (g/mol) | 111,808 | 99,357 |
| Mw/Mn(abs) | 2.9 | 2.9 |
| Mz/Mw(abs) | 2.1 | 2.0 |
| Mz/Mn(abs) | 6.2 | 5.8 |
| #SCB at Mn | 4.05 | 0.97 |
| #SCB at Mz | 7.65 | 1.33 |
| BOCD index | 4.6 | 0.5 |
| (Mn − Mz Comonomer Slope Index) | | |
| g′(vis) | 0.98 | 0.98 |
| hexene (wt %) | 3.41 | 0.91 |
| TREF Peak temperature (° C.) | 94 | 96 |
| TREF 50 wt % temperature (° C.) | 89 | 95 |
| wt % elution Temp. <90° C. by | 54.9 | 11.5 |
| TREF (wt %) | | |
| wt % of elution Temp. >95° C. by | 6.3 | 54.5 |
| TREF (wt %) | | |

N.M.—not measured

The produced polyethylene granules were compounded with IRGONOX™ 3114 (a sterically hindered phenolic antioxidant, available from BASF) and IRGOFOS™ 168 (a hydrolytically stable phosphite stabilizer, available from BASF). The final resin had 600 ppm IRGONOX™ 3114 and 1200 ppm IRGOFOS™ 168.

Bicomponent fibers were produced with a core-sheath configuration with the polyethylene as the sheath and a polyethylene terephthalate (PET) core, using conventional parameters known to those skilled in the art. In brief summary, the molten polymers went through a melt pump and were sprayed out from spinners to produce filaments. Each spinner contained thousands of pinholes, each of about a few micrometers in diameter. Then, the filaments were collected together and passed several heating elements (such as water bath, steam oven, dryers). Finally, the filaments were cured and cut into staple fiber.

Four types of bicomponent staple fibers were produced: (1) core PET with 2911FS (high density polyethylene, available from Fushun Petro Chemical) sheath, (2) core PET with IE1sheath, (3) core PET with ASPUN™ 6000 (linear low density polyethylene, available from Dow) sheath, and (4) core PET with IE2 sheath. The 2911FS and ASPUN™ 6000 include antioxidants in their formulations. Various properties of the two polyethylenes used in comparative fiber production is provided in Table 3 along with the properties of other polyethylene grades. The properties of the four staple fiber samples is provided in Table 4.

TABLE 3

| | | ASPUN ™ | EXCEED ™ | ENABLE ™ | |
|---|---|---|---|---|---|
| Composition | 2911FS | 6000 | 0019XC | 4002 | 7200F |
| Density (g/cm³) | 0.96 | 0.935 | 0.918 | 0.94 | 0.963 |
| Melt Flow Index | 21 | 19 | 19 | 0.2 | 7.5 |
| (190° C. with 2.16 | | | | | |
| kg load) (g/10 min) | | | | | |
| Melt Flow Index | N.M. | N.M. | n/a | 14 | n/a |
| (190° C. with 21.6 | | | | | |
| kg load) (g/10 min) | | | | | |
| Melt Index Ratio | N.M. | N.M. | n/a | 70 | n/a |
| Mn(abs) (g/mol) | 14,448 | N.M. | 17,762 | 23,940 | 15,136 |
| Mw(abs) (g/mol) | 54,905 | N.M. | 51,518 | 122,023 | 77,865 |
| Mz(abs) (g/mol) | 160,447 | N.M. | 86,637 | 240,413 | 291,533 |
| Mw/Mn(abs) | 3.8 | N.M. | 2.9 | 5.1 | 5.1 |
| Mz/Mw(abs) | 2.9 | N.M. | 1.7 | 2.0 | 3.7 |
| Mz/Mn(abs) | 11.1 | N.M. | 4.9 | 10.0 | 19.3 |
| #SCB at Mn | no SCB | N.M. | 14.40 | 2.98 | no SCB |
| #SCB at Mz | no SCB | N.M. | 15.60 | 3.33 | no SCB |
| BOCD index | no SCB | N.M. | 1.7 | 0.3 | no SCB |
| g′(vis) | 0.96 | N.M. | 0.97 | 0.96 | 0.934 |
| hexene (wt %) | 0.01 | N.M. | 9.34 | 1.98 | 0.02 |
| TREF Peak | 98 | N.M. | 79 | 95 | 99 |
| temperature (° C.) | | | | | |
| TREF 50 wt % | 98 | N.M. | 75 | 95 | 99 |
| temperature (° C.) | | | | | |
| wt % elution | 9.1 | N.M. | 99.3 | 6.9 | 8.8 |
| Temp. <90° C. by | | | | | |
| TREF (wt %) | | | | | |
| wt % of elution | 84.6 | N.M. | 0 | 6.4 | 86.5 |
| Temp. >95° C. by | | | | | |
| TREF (wt %) | | | | | |

N.M.—not measured
EXCEED ™ 0019XC—ethylene 1-hexene copolymer, available from ExxonMobil
ENABLE ™ 4002—medium density ethylene 1-hexene copolymer, available from ExxonMobil
7200F—high density polyethylene, available from Taisox

TABLE 4

| | | | |
|---|---|---|---|
| | First Melt | Second Melt | Crystallization |
| | Main Peak | Main Peak | Main Peak |
| Composition | (° C.) | (° C.) | (° C.) |

Pellets

| | | | |
|---|---|---|---|
| 2911FS | 132.8 | 132.6 | 115.5 |
| EM 1 | 126.6 | 126.3 | 110.7 |
| ASPUN ™ | 128.7 | 127.0 | 111.8 |
| 6000 | | | |
| EM 2 | 129.8 | 130.3 | 114.6 |

As-Produced Bicomponent Fiber

| | | | | | | |
|---|---|---|---|---|---|---|
| 2911FS//PET* | 130.2 | 253.0 | 131.8 | 246.9 | 118.2 | 192.7 |
| EM 1//PET | 124.0 | 253.2 | 124.35 | 246.4 | 113.6 | 206.0 |
| ASPUN ™ | 126.5 | 253.0 | 126.5 | 246.4 | 115.4 | 201.5 |
| 6000//PET | | | | | | |
| EM 2//PET | 127.2 | 253.2 | 128.7 | 247.6 | 116.6 | 209.7 |

Bicomponent Staple Fiber

| | | | | | | |
|---|---|---|---|---|---|---|
| 2911FS//PET | 132.3 | 250.1 | 133.3 | 249.6 | 119.5 | 215.9 |
| EM 1//PET | 122.9 | 249.6 | 124.7 | 249.1 | 113.1 | 204.4 |
| ASPUN ™ | 126.9 | 249.6 | 127.2 | 243.6 | 115.6 | 201.7 |
| 6000//PET | | | | | | |
| EM 2//PET | 127.8 | 249.7 | 129.2 | 249.1 | 116.7 | 214.2 |

*For bicomponent fibers, the nomenclature is sheath//core.

First, comparing the different polyethylenes (not as the fiber) the melt flow index and densities of the inventive polyethylenes are similar to those of comparative examples. However, surprisingly, (1) the inventive polyethylenes have lower Mw/Mn values, indicating narrower molecular weight distribution making it suitable for fiber spinning processes; and (2) the balance of high density and low density fraction in the composition is tunable by density. The novel and tunable co-monomer distribution is particularly useful for staple fiber applications.

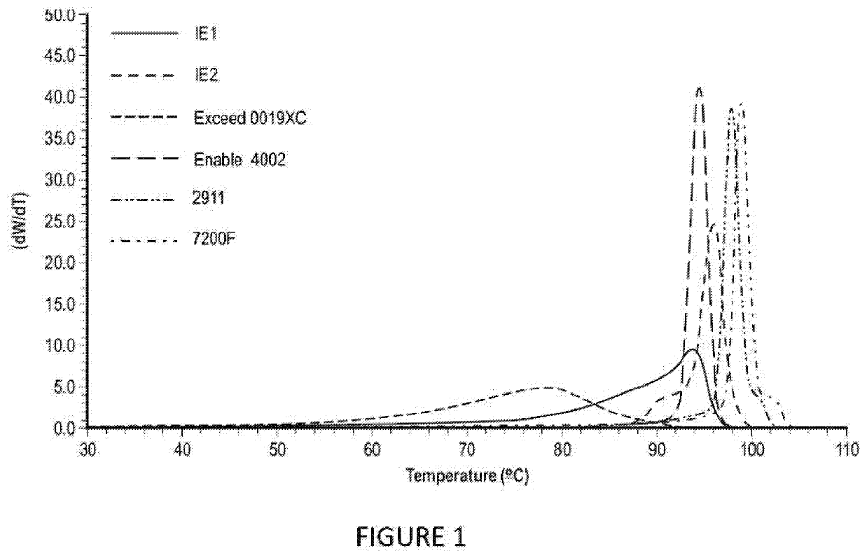

In addition to Tables 2, 3 and 4, reference FIG. 1 for a TREF comparison for some of the polyethylenes reported in Tables 2 and 3, and for further explanation of the balance of high and low density fractions in IE1 and IE2. In particular, FIG. 1 illustrates the inventive polyethylenes IE1 and IE2 having clear peaks in their TREF elution, but the peaks are broadened, with portions of eluted polymer at and below 90° C., and portions of eluted polymer at and above 95° C. For instance, IE1 shows a very broad peak with shoulder conjoined therewith; and while IE2 shows a more distinct peak, it also includes a shoulder spanning approx. 88° C.-92° C. Both IE TREF curves indicate the presence of two distinct density fractions (that is, a high density fraction and a low density fraction), as compared to the other polymers illustrated on FIG. 1, having either substantially all of their eluted polymer less than 90° C. (Exceed 0019XC) or almost no eluted polymer below 90° C. (Enable 4002, 2911, 7200F). Another way of quantifying this feature of the inventive polymers is through the comparison of TREF peak elution temperature vs. TREF 50 wt % elution temperature, with a reminder that TREF peak elution temperature is defined as the temperature at the maximum dW/dT ([wt %]/° C.), while TREF 50 wt % elution temperature is defined as the temperature when accumulated 50 weight % of composition is eluted. Specifically, in these inventive polyethylenes, the TREF peak elution temperature is greater than the TREF 50 wt % elution temperature, quantifying the existence of the shoulder to the left side (lower-temperature side) of each of the elution peaks illustrated in IE1 and IE2 in FIG. 1.

Another surprising and useful feature stands out in FIG. 1 from comparing IE1 and IE2: tunable balance of high and low density fractions on the basis of overall density. That is, as more comonomer is incorporated into the polymer chains of these inventive polyethylenes (i.e., density is decreased), as is the case for moving from IE2 to IE1, the comonomer is incorporated into a distinct fraction of the polymer chains (hence the larger and larger area under the TREF curve below 90° C. in IE1, as compared to the TREF curve below 90° C. for IE2), rather than being distributed equally along the polymer chains and losing the distinction of the fractions entirely. This feature provides a substantial advantage particularly in the bicomponent fiber space, where the distinct higher and lower density fractions each give important advantages.

For example, EXCEED™ 0019XC has a melt index 19, which is comparable to IE1. However, reviewing the TREF data (see FIG. 1) 99.8 wt % of the EXCEED™ 0019XC elutes at the temperature lower than 92° C., indicating lower melting point and lower temperature required to bond the fibers. However, the fabrics made from bicomponent fibers containing EXCEED™ 0019XC are mechanically weak. The mechanical strength of the fiber and fabric is in line with the low density of resins. As seen below, nonwoven fabrics produced with bicomponent fibers comprising IE1 have good mechanical strength, while the substantial portion of lower-eluting polymer (low density fraction) corresponds to an portion of relatively lower-melting polymer that is adequately large to still enable lower-temperature bonding for IE1, even while maintaining that good mechanical strength.

ENABLE™ 4002 also has similar density to IE1, but ENABLE™ 4002 has a very narrow co-monomer distribution as shown in the TREF graph. About 6.9% composition eluted at temperature lower than 90° C. and 10.3% composition eluted at temperature greater than 95° C. The bonding temperature window is very narrow for ENABLE™ 4002, which may translate to the fiber-to-fiber bonding being weaker. In addition, the broad Mw/Mn and high melt index ratio of ENABLE™ 4002 would likely lead to strain hardening, making it unsuitable for fine fiber spinning.

2911FS and 7200F are both typical HDPE resins used in the industry. Both have greater than 80% of composition eluted at higher than 95° C., indicating the good bonding strength once formed. However, for both of these polyethylenes, the bonding temperature is high and the bonding temperature range is narrow. Without being limited by theory, it is believed that the high bonding temperature and narrow bonding temperature range is because these polyethylenes lack low density fractions. In addition, 2911FS and 7200F produce nonwoven fabrics having poor hand touch softness ratings.

In contrast, IE1 and IE2 have both (a) more than 10% of the composition eluted at temperature lower than 90° C. (see FIG. 1) and (b) more than 5% of their composition eluted at temperatures greater than 95° C. It is believed that this unique composition, having both elution fractions, enables lower bonding temperature, broader bonding temperature window and good bonding strength of the bicomponent fibers. The overall lower density for IE1 and IE2 (especially as compared to HDPEs 2911FS and 7200F) may also provide soft hand touch.

As noted above, the density of IE1 and IE2 appears to not only affect co-monomer distribution along the molecular weight, but also affects the balance of high density and low density fractions, which appears to be contrary to traditional wisdom. This unique phenomenon of tunability may allow for fine-tuning the density of the polyethylene composition to accommodate different process and material needs of different customers. That is, an additional advantage of the inventive polymers lies in the ability to use density (comonomer amount) to tune the size of the low-density fraction, changing the balance of easy processing (low/broad melt window) vs. strength, while still maintaining adequate strength even at lower-temperature melting point/fiber bonding point.

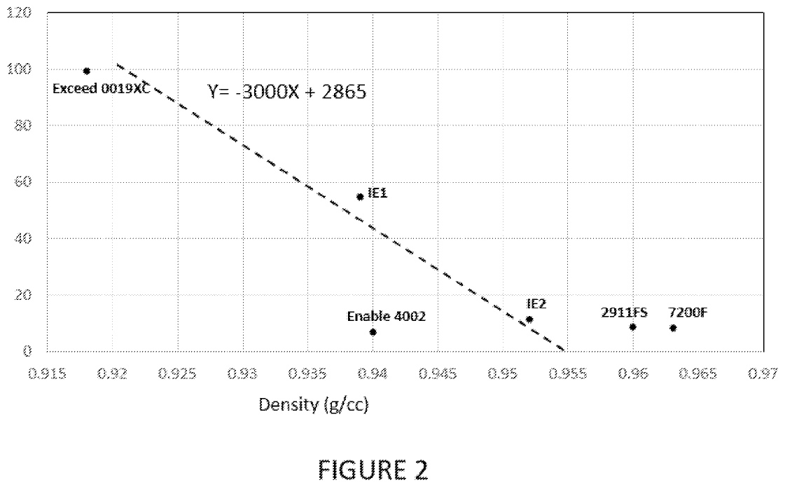

This feature is further illustrated in FIG. 2, which provides an additional way of quantifying this unique affect (as density decreases, i.e., comonomer incorporation increases, the comonomer is preferentially incorporated into the identifiable low-density fraction of the polyethylene). FIG. 2 is a graph illustrating wt % of polymer eluting below 90° C. in the TREF experiment (Y-axis) as a function of density (X-axis) for the various example polymers. As can be seen, the inventive polyethylene copolymers follow this relationship: Y>−3000X+2865, where Y is wt % of TREF elution at 90° C. or less; and X is density (g/cm³); and furthermore have density within the range 0.930 to 0.955 g/cm³. At density values above about 0.955 g/cm³ (and in particular with reference to the HDPE homopolymers 2911FS and 7200F), the relationship becomes a non-sequitur, since such samples are homopolymers having no comonomer, and thus tunable comonomer incorporation is inapposite to the analysis of such polymers. As noted, the lower density of the present polyethylenes provides advantageous softer hand touch for bicomponent fiber applications as compared to HDPE, while also offering lower melt (easier processing)—which, as just noted, is tunable in the present polyethylenes, allowing ready balance of ease of processing vs. good mechanical strength.

The four staple fiber samples from Table 4 were used to produce nonwoven fabrics. Briefly, the staple fibers were opened and supplied to a carding machine to de-aggregate the staple fibers. The resultant web was passed through an oven for through-air bonding. The temperature of the through-air and line speed through the oven are known to the skilled person in the art. While it is typical for the reference PET/PE bico fiber process to use about 165° C. or higher temperature, such as 170° C., it was discovered that the EM 1//PET staple fiber sample could be bonded at 160° C. The properties of the resultant nonwoven fabrics are provided in Table 5.

TABLE 5

| | | PET // | PET // | PET // |
|---|---|---|---|---|
| | PET // | ASPUN ™ | EM 1 | EM 1 |
| | EM 2 | 6000 | (168° C.) | (160° C.) |
| Gauge (g/m²) | 15.2 | 22.7 | 24.0 | 22.9 |
| Machine direction | 29.6 | 29.9 | 32.7 | 31.1 |
| tensile force at | | | | |
| max (N) | | | | |
| Machine direction | 31 | 34 | 27 | 29 |
| tensile elongation | | | | |
| at max (%) | | | | |
| Cross direction | 6.2 | 6.3 | 5.5 | 5.8 |
| tensile force at | | | | |
| max (N) | | | | |
| Cross direction | 62 | 65 | 66 | 61 |
| tensile elongation | | | | |
| at max (%) | | | | |
| Hand-o-meter (g) | 19.3 | 17.9 | 12.6 | 13.3 |

In the fabrication process of the nonwoven fabrics, Fiber PET//EM 1 and PET//EM 2 both demonstrated lower bonding temperature than those fibers made by other polyethylenes with similar density, which may allow for a broader operation window and lower power consumption.

The nonwoven fabrics made from PET//EM 1 demonstrates lower Hand-O-meter value, which translates to a softer hand feeling, when comparing with the PET//ASPUN™ 6000.

Therefore, the present invention is well adapted to attain the ends and advantages mentioned as well as those that are inherent therein. The particular examples and configurations disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative examples disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Similarly, where multiple ranges are disclosed (e.g., from 1 to 100 or from 10 to 90, such as 30 to 75), ranges from any disclosed lower end to any disclosed higher end are specifically contemplated (e.g., from 10 to 75). Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

The invention claimed is:

1. A composition comprising:
polyethylene comprising about 90 wt % to about 99.99 wt % ethylene-derived units and 0.01 wt % to 10 wt % of units derived from an alpha-olefin that is not ethylene, wherein the polyethylene has:
a density of 0.930 g/cm³ to 0.955 g/cm³,
a melt flow index (MI, measured at 190°° C., 2.16 kg loading) of 10 g/10 min to 50 g/10 min,
a melt flow index ratio (MIR) of 15 to 25,
a weight average molecular weight to number average molecular weight ratio (Mw/Mn) of 2 to 4,
a wt % of TREF elution at 90° C. and less of 10 wt % to 80 wt %, and
a wt % of TREF elution at 95°° C. and greater of 3 wt % or more.

2. The composition of claim 1, further wherein:
(a) a TREF peak elution temperature of the polyethylene is greater than a TREF 50 wt % elution temperature of the polyethylene; and/or
(b) the polyethylene follows comonomer incorporation relationship Y>−3000X+2865, where Y is the wt % of TREF elution at 90° C. or less of the polyethylene, and X is the density (g/cm³) of the polyethylene.

3. The composition of claim 1, wherein the Mw/Mn of the polyethylene is 2 to 3.

4. The composition of claim 1, wherein the density of the polyethylene is 0.930 g/cm³ to 0.945 g/cm³.

5. The composition of claim 1, wherein the polyethylene has a broad orthogonal composition distribution (BOCD) index of greater than 2.

6. The composition of claim 1, wherein the alpha-olefin is 1-hexene.

7. A method comprising:
polymerizing ethylene and an alpha-olefin that is not ethylene in a fluidized bed gas reactor in the presence of a hafnocene catalyst to produce a polyethylene, wherein a reactor pressure is less than 300 psig, wherein the polyethylene comprises 90 wt % to 99.99 wt % ethylene-derived units and 0.01 wt % to 10 wt % alpha-olefin-derived units, and wherein the polyethylene has:
a density of 0.930 g/cm³ to 0.955 g/cm³,
a melt index (MI) of 10 g/10 min to 50 g/10 min,
a melt index ratio (MIR) of 15 to 25,
a weight average molecular weight to number average molecular weight ratio (Mw/Mn) of 2 to 4,
a TREF elution at 90° C. and less of 10 wt % to 80 wt %, and
a TREF elution at 95°° C. and greater of 3 wt % or more.

8. The method of claim 7, wherein the alpha-olefin is 1-hexene.

9. The method of claim 7, wherein a reactor bed temperature during the polymerizing is 70° C. to 80° C.

10. The method of claim 7, wherein a catalyst productivity during the polymerizing is 7000 g/g or greater.

11. The method of claim 7, further wherein:
(a) a TREF peak elution temperature of the polyethylene is greater than a TREF 50wt % elution temperature of the polyethylene; and/or
(b) the polyethylene follows comonomer incorporation relationship Y>−3000X+2865, where Y is the wt % of TREF elution at 90°° C. or less of the polyethylene, and X is the density (g/cm³) of the polyethylene.

12. The method of claim 7, wherein the Mw/Mn of the polyethylene is 2 to 3.

13. The method of claim 7, wherein the density of the polyethylene is within the range from 0.930 g/cm³ to 0.945 g/cm³.

14. The method of claim 7, wherein the polyethylene has a broad orthogonal composition distribution (BOCD) index of greater than 2.

15. A bicomponent fiber comprising:
a first polymeric component comprising one or more of: a polypropylene, a polyethylene terephthalate, a polyamide, a poly (oxyethylene glycol) polymer, a polyoxymethylene, or a polyether ether ketone; and
a second polymeric component comprising: the polyethylene of any of claims 1-6.

16. The bicomponent fiber of claim 15, wherein the bicomponent fiber has the core-sheath configuration with the second polymeric component as the sheath.

17. The bicomponent fiber of claim 15, wherein the bicomponent fiber is a bicomponent staple fiber.

18. A method comprising:
melt spinning the bicomponent fiber of claim 15;
cutting the bicomponent fiber into a bicomponent staple fiber;
producing a nonwoven fabric with the bicomponent staple fiber with an air-through bonding temperature of 180° C. or less.

19. The method of claim 18, wherein the air-through bonding temperature of 150° C. to 165° C.

20. The method of claim 18 further comprising:
stretching the bicomponent fiber before the cutting of the bicomponent fiber.
